(19) United States
(12) Patent Application Publication
(10) Pub. No.: US 2025/0086726 A1
(43) Pub. Date: Mar. 13, 2025

(54) METHODS AND SYSTEMS FOR obtaining aN insurance product using equity of a residential property

(71) Applicant: Cornerstone Financing LLC, Essex Fells, NJ (US)

(72) Inventors: Craig Corn, Essex Fells, NJ (US); Daniel Anderson, Essex Fells, NJ (US)

(73) Assignee: Cornerstone Financing LLC, Essex Fells, NJ (US)

(21) Appl. No.: 18/463,591

(22) Filed: Sep. 8, 2023

(51) Int. Cl. G06Q 40/08

(52) U.S. Cl. CPC G06Q 40/08

(57) ABSTRACT

This disclosure provides novel methods and systems for obtaining a retirement-oriented insurance product using the equity of residential property through a home equity insurance financing solutions (HEIFS) subsystem. In particular, the amount of equity of the residential property available for financing the insurance premium is not leveraged through the debt product, and the disclosed methods and systems do not require payments from the homeowner until the homeowner passes away or permanently moves out of the residential property.

### FIELD

This invention relates generally to methods and systems for obtaining a retirement-oriented insurance product using the equity of residential property through a home equity insurance financing solutions (HEIFS) subsystem.

### BACKGROUND

Since home equity is not an asset that can be freely traded and monetized like a stock or bond, it is often considered a dormant asset that agents or advisors do not give much consideration to when it comes to financial and retirement planning. In addition, research has long confirmed that most homeowners, especially older homeowners, have a strong desire to age in their current homes, which means monetizing home equity through the sale of their current home and downsizing into a smaller home is often not a practical option for agents or advisors to consider when it comes to financial/retirement planning. Moreover, many homeowners who have purchased their homes using a mortgage are usually reluctant to take on more debt as they get older, given that they have spent many years paying down their mortgage. This phenomenon has resulted in older homeowners becoming debt-adverse as they get older, and usually very wary of debt products, such as reverse mortgages and home equity lines of credit, as a means to monetize their home equity while continuing to stay in their homes. Ironically, older homeowners have long demonstrated a desire to not only want to age in their homes, but also are comfortable using their home equity to do so, as long as it is not in the form of debt.

Accordingly, there is a strong need for improved methods and systems for obtaining a retirement-oriented insurance product.

### SUMMARY

This disclosure addresses the need mentioned above in a number of aspects. In one aspect, this disclosure provides a system of obtaining a retirement-oriented insurance product using equity of a residential property through a home equity insurance financing solutions (HEIFS) subsystem. In some embodiments, the HEIFS subsystem is configured to: (a) receive a communication from an agent or advisor of a homeowner of the residential property, wherein the communication is indicative of an intent of the homeowner to purchase a retirement-oriented insurance product that is pre-approved by the HEIFS subsystem; (b) acquire information about the homeowner from the agent or advisor; (c) determine amount of equity of the residential property available for financing an insurance premium based on factors comprising an existing mortgage or home equity line of the residential property and a pledged home equity factor based on the information about the homeowner; (d) determine amount of insurance proceeds that can be generated through the HEIFS subsystem based on the amount of equity of the residential property available for financing the insurance premium and communicate the amount of insurance proceeds to the agent or advisor; (e) determine the retirement-oriented insurance product suitable for the homeowner based on the amount of insurance proceeds; and (f) obtain approval from an insurance carrier that provides the retirement-oriented insurance product, wherein the retirement-oriented insurance product is not obtained through a debt product.

In some embodiments, the amount of equity of the residential property available for financing the insurance premium is not leveraged through the debt product. In some embodiments, the system does not require payments from the homeowner until the homeowner passes away or permanently moves out of the residential property.

In some embodiments, the HEIFS subsystem is further configured to engage an underwriter to finance the insurance premium. In some embodiments, the underwriter is a warehouse lender.

In some embodiments, the HEIFS subsystem is further configured to securitize collaterals associated with financing the insurance premium. In some embodiments, the HEIFS subsystem is further configured to engage one or more reinsurance companies to reinsure the retirement-oriented insurance product.

In some embodiments, the residential property is a single-family house.

In some embodiments, the retirement-oriented insurance product comprises one or more of annuity, life insurance, and long-term care insurance. In some embodiments, the retirement-oriented insurance product comprises a life insurance policy.

In some embodiments, the information about the homeowner comprises one or more of a name of the homeowner, an address of the residential property, an estimated home value of the residential property, and existing mortgage or debt on the residential property.

In some embodiments, the amount of equity of the residential property available for financing the insurance premium is calculated by the following equation:

VE=(p*value of the residential property−the existing mortgage or home equity line)/the pledged home equity factor,
wherein VE is the amount of equity of the residential property available for financing the insurance premium, and p is a percentage of the value of the residential property that is permitted for financing the insurance premium. In some embodiments, p is about 50% of the value of the residential property. In some embodiments, the pledged home equity factor is from about 1.5 to about 3.

In some embodiments, the HEIFS subsystem is further configured to determine the value of the residential property through one or more automated valuation models.

In some embodiments, the HEIFS subsystem is further configured to take a second lien position if there is an existing lien associated with the residential property.

In another aspect, this disclosure provides a method of obtaining a retirement-oriented insurance product using equity of a residential property through a home equity insurance financing solutions (HEIFS) subsystem. In some embodiments, the method comprises: (i) receiving, by the HEIFS subsystem, a communication from an agent or advisor of a homeowner of the residential property, wherein the communication is indicative of an intent of the homeowner to purchase a retirement-oriented insurance product that is pre-approved by the HEIFS subsystem; (ii) acquiring, by the HEIFS subsystem, information about the homeowner from the agent or advisor; (iii) determining, by the HEIFS subsystem, amount of equity of the residential property available for financing an insurance premium based on factors comprising an existing mortgage or home equity line of the residential property and a pledged home equity factor based on the information about the homeowner; (iv) determining, by the HEIFS subsystem, amount of insurance proceeds that can be generated through the HEIFS subsystem based on the amount of equity of the residential property available for financing the insurance premium and communicating the amount of insurance proceeds to the agent or advisor; (v) determining, by the HEIFS subsystem, the retirement-oriented insurance product suitable for the homeowner based on the amount of insurance proceeds; and (vi) obtaining, by the HEIFS subsystem, approval from an insurance carrier that provides the retirement-oriented insurance product, wherein the retirement-oriented insurance product is not obtained through a debt product.

In some embodiments, the amount of equity of the residential property available for financing the insurance premium is not leveraged through the debt product. In some embodiments, the method does not require payments from the homeowner until the homeowner passes away or permanently moves out of the residential property.

In some embodiments, the method further comprises engaging, by the HEIFS subsystem, an underwriter to finance the insurance premium. In some embodiments, the underwriter is a warehouse lender.

In some embodiments, the method further comprises securitizing, by the HEIFS subsystem, collaterals associated with financing the insurance premium.

In some embodiments, the method further comprises engaging, by the HEIFS subsystem, one or more reinsurance companies to reinsure the retirement-oriented insurance product.

In some embodiments, the residential property is a single-family house.

In some embodiments, the retirement-oriented insurance product comprises one or more of annuity, life insurance, and long-term care insurance. In some embodiments, the retirement-oriented insurance product comprises a life insurance policy.

In some embodiments, the information about the homeowner comprises one or more of a name of the homeowner, an address of the residential property, an estimated home value of the residential property, and existing mortgage or debt on the residential property.

In some embodiments, the amount of equity of the residential property available for financing the insurance premium is calculated by the following equation:

VE=(p*value of the residential property−the existing mortgage or home equity line)/the pledged home equity factor,
wherein VE is the amount of equity of the residential property available for financing the insurance premium, and p is a percentage of the value of the residential property that is permitted for financing the insurance premium. In some embodiments, p is about 50% of the value of the residential property. In some embodiments, the pledged home equity factor is from about 1.5 to about 3.

In some embodiments, the method further comprises determining, by the HEIFS subsystem, the value of the residential property through one or more automated valuation models.

In some embodiments, the method further comprises, by the HEIFS subsystem, taking a second lien position if there is an existing lien associated with the residential property.

The foregoing summary is not intended to define every aspect of the disclosure, and additional aspects are described in other sections, such as the following detailed description. The entire document is intended to be related as a unified disclosure, and it should be understood that all combinations of features described herein are contemplated, even if the combination of features are not found together in the same sentence, or paragraph, or section of this document. Other features and advantages of the invention will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### BRIEF DESCRIPTION OF THE DRAWINGS

FIG. 1 shows an example home equity-backed product and financing ecosystem.

FIG. 2 shows an example process for obtaining a retirement-oriented insurance product using equity of a residential property through a home equity insurance financing solutions (HEIFS) subsystem.

FIG. 3 shows an example computing system for implementing the disclosed methods.

### DETAILED DESCRIPTION

This disclosure provides novel methods and systems for obtaining a retirement-oriented insurance product using equity of a residential property through a home equity insurance financing solutions (HEIFS) subsystem. Importantly, the retirement-oriented insurance product is not obtained through a debt product. In particular, the amount of equity of the residential property available for financing the insurance premium is not leveraged through the debt product, and the disclosed methods and systems do not require payments from the homeowner until the homeowner passes away or permanently moves out of the residential property.

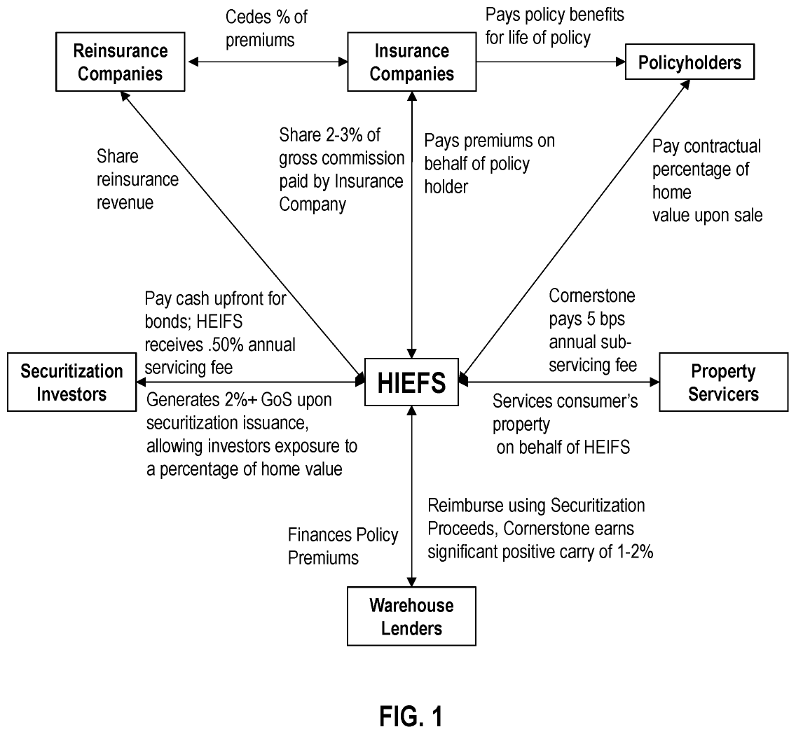

As shown in FIG. 1, the disclosed methods and systems integrate participation of all parties in providing a retirement-oriented insurance product. Homeowners are interested in aging in place and improving their retirement outcomes through the purchase of retirement-oriented insurance products. Agents or advisors are interested in providing their clients (e.g., homeowners) recommendations as to which insurance products will best meet their needs, and importantly provide alternative options to finance the purchase of these insurance products besides the use of cash. Insurance carriers are interested in issuing retirement-oriented insurance products to provide agents or advisors the ability to help their clients better age in place and improve retirement outcomes, and to receive premiums to pay for the issuance of these insurance products.

HEIFS provides agents or advisors the ability to utilize their client's dormant home equity as a means to finance the purchase of retirement-oriented insurance products. The term “HEIFS” is used interchangeably with the term “HEIFS subsystem.” Warehouse lenders provides HEIFS the ability to finance the premiums that are paid to insurance carriers on behalf of the policyholder/homeowner, from time of HEIFS financing to the time HEIFS are collateralized in securitization trusts and packaged as securities for sale to institutional investors. Reinsurance companies develop proprietary insurance products that best fit the HEIFS financing structure and that better meet the needs to agents or advisors and their clients. Property sub-servicers service the underlying HEIFS collateral, such as single-family residential property, on behalf of securitization investors through the HEIFS subsystem. Securitization investors have a desire to gain access to low loan-to-value (LTV) single-family residential property exposure through the purchase of securities collateralized through the HEIFS subsystem.

The process starts by utilizing the critical relationship between agents or advisors and their clients. The agents or advisors are in the business of providing financial advice and selling investment/insurance products that help their clients achieve their financial and retirement goals. This advice and these products are typically centered around supporting the health, income, wealth creation and legacy planning that agents or advisors attempt to provide to their clients.

A classic financial planning approach is to ensure that their clients have a foundation of protection products that form the foundation of critical financial/retirement planning, products such as annuities, life insurance and long-term care insurance. Once the foundation has been laid, agents or advisors will typically look to manage their clients remaining financial assets (e.g., stocks, bonds, etc.) in a manner that best meets their clients' needs, taking into considerations factors such as age and investment posture (conservative to aggressive), with the ultimate goal of creating a nest egg that can be comfortably drawn down in retirement. Often times, a client's largest asset is their house, and in particular the home equity that the client has built up over time.

As used herein, the term “home equity” refers to a current home value less a debt against the house, such as a mortgage or home equity line. Home equity is not an asset that can be freely traded and monetized like a stock or bond. Thus, it is often considered a dormant asset and not given much consideration to when it comes to financial and retirement planning. In addition, most homeowners, especially older homeowners, have a strong desire to age in their current homes, which means monetizing home equity through the sale of their current home and downsizing into a smaller home is often not a practical option for agents or advisors to consider when it comes to financial/retirement planning. Moreover, many homeowners who have purchased their homes using a mortgage are usually reluctant to take on more debt as they get older, given that they have spent many years paying down their mortgage. As a result, older homeowners become debt-adverse as they get older and are usually very wary of debt products such as reverse mortgages and home equity lines of credit as a means to monetize their home equity while continuing to stay in their homes. Ironically, older homeowners have long demonstrated a desire to not only want to age in their homes, but also are comfortable using their home equity to do so, as long as it is not in the form of debt.

The disclosed methods and systems address this issue by creating HEIFS, which allows homeowners to pledge a percentage of the future value of their home in return for the HEIFS subsystem to provide an upfront dollar benefit. Unlike debt, HEIFS are an investment in single family residential property. Also, unlike debt, where the borrower can use their borrowed debt proceeds for any purpose they so choose, proceeds from a HEIFS transactions are specifically used to purchase certain guaranteed insurance products that are recommended by the homeowner's agents or advisors. This requirement allows agents or advisors to consider home equity in the financial/retirement planning process, and to use that home equity to specifically fund the purchase of guaranteed insurance products that the agents or advisors, in consultation with their client, feel will best help their client better age in place and improve their retirement outcomes.

There is over $14 trillion of home equity for homeowners over the age of 50 in the United States. However, in existing methods, the amount of home equity could only be leveraged through debt, which is something that homeowners, especially older homeowners, are reluctant to consider, which does not take into account the fact that they may not even be able to qualify for debt, which is a requirement for taking on products like a reverse mortgage or home equity line.

HEIFS solves the qualifying issue because, with HEIFS, there is no payment that needs to be made by the HEIFS homeowner; rather, their only required payment is when the homeowners pass away or permanently moves out of their house, which is when HEIFS become due and payable. The HEIFS subsystem will establish relationships with hundreds of brokerage general agencies and thousands of insurance agents and advisors, both independent and captive, which allow these agents or advisors to offer their clients the ability to purchase retirement-oriented insurance products either through the traditional means of paying in cash or by using the HEIFS subsystem. If the decision is to use the HEIFS subsystem, the process is streamlined. First, the agents or advisors inform the HEIFS subsystem of their intent to have their client use the HEIFS subsystem to purchase one or more of the insurance products that have been approved for HEIFS funding. The agents or advisors enter information about the homeowner in their insurance origination system into the HEIFS subsystem. The information includes the name of homeowner, address, estimated home value, any existing mortgage/debt on the house, etc.

The HEIFS subsystem will use this information to provide the agents or advisors with preliminary information about the amount of insurance proceeds that can be generated using the HEIFS subsystem. This process involves providing the agents or advisors access by the HEIFS subsystem to any number of market automated valuation models (AVM) that can help the agents or advisors determine an estimated value of their client's home. With this information, the HEIFS subsystem can then determine, based on the amount of any existing debt on the client's home, how much of the home's equity can be shared with the HEIFS subsystem and, accordingly, how much the HEIFS subsystem can provide the homeowner to finance their insurance premium.

As an example, if a homeowner has a $1,000,000 home and has an existing mortgage of $100,000, the HEIFS subsystem determines that the homeowner can pledge no more than 90% of the value of their home (10% is already pledged to the lender that has lent $100,000). However, it is important that the homeowner maintains a significant amount of equity in their home for themselves, which is intended to create an optimal alignment of interests. Thus, the most that the HEIFS subsystem will allow a homeowner to pledge is equal to a predetermined percentage (such as 50% of the value of their home) less any existing debt expressed as a percentage of the value of their home. In this example, since the homeowner has an existing mortgage of $100,000, which is 10% of the value of their home (10% loan to value, or LTV), the HEIFS subsystem will only accept the homeowner pledging 40% of the future value of the home to the HEIFS subsystem, which would result in a combined loan to value (CLTV) of 50%.

Based on the homeowner pledging 40% of the value of their home to the HEIFS subsystem, the HEIFS subsystem will provide insurance premium financing in an amount equal to 40% divided by a pledged home equity factor (e.g., from 1.5 to 3), times the value of the home. For example, if the pledged home equity factor is 2, then the amount of insurance premium financing that is made available would be 40% divided by 2 and times $1,000,000, which equals $200,000. At this point, the agents or advisors would know that their client has the ability to generate $200,000 of HEIFS financing, which means the client has the ability to purchase retirement-oriented insurance products with premiums equal to $200,000 or less.

The agents or advisors continue to work with the client on getting approved for the insurance policy. Once the policy is medically approved (or if an annuity is just approved), the HEIFS subsystem will begin the process of fulfilling the homeowner's HEIFS transaction, which involves the following one or more of the following steps. First, the HEIFS subsystem orders an appraisal to ensure that the estimated home value determined through an AVM is consistent with the appraisal. Once the appraisal is in, any adjustments that need to be made to the insurance policy will be made. Next, the HEIFS subsystem orders title insurance by working with any number of title insurance brokers in the country. If there is no existing lien on the property (i.e., no existing mortgage), then the HEIFS financing will be in the first lien position, and the title insurance will be purchased to reflect that. If there is an existing lien on the property (i.e., an existing mortgage), then the HEIFS financing will be in the second position, and the title insurance will be purchased to reflect that.

Next, documents are created that reflect the transaction between the homeowner and the HEIFS subsystem, which involves the following: (a) initial disclosure package, which includes an application, privacy notices, and other disclosures often found in consumer lending transactions; (b) a performing mortgage or deed of trust, which reflects the fact that HEIFS has an interest in the HEIFS homeowner's home; (c) a insurance premium funding agreement, which reflects the fact that the homeowner has pledged a certain percentage of the value of their property, and in return, the HEIFS subsystem has provided the insurance premium financing on the insurance product that they have purchased; and (d) a final disclosure package, which is nearly identical to the initial disclosure package, but reflects the final terms and conditions of the HEIFS financing transaction.

Once the final disclosure package has been signed by the homeowner and HEIFS, HEIFS will send the HEIFS proceeds directly to the insurance carrier that issued the insurance policy(s) that are being financed by HEIFS proceeds. At this point, the transaction between HEIFS and the homeowner has been consummated, and HEIFS will begin the process of uploading the homeowner information to HEIFS's sub-servicer, who will then begin to conduct servicing activities on HEIFS's behalf (and on behalf of other counterparties involved in HEIFS). In addition, HEIFS will look to the insurance carrier to be compensated out of the total commission allowable generated by the issuance of the policy.

In order to finance the insurance premiums that are paid to the carrier at the time a HEIFS financing transaction is consummated, HEIFS enters into one or more warehouse financing arrangements that allow HEIFS to borrow money from these warehouse lenders during the period of time from HEIFS closing/funding to the time HEIFS are securitized into permanent financing. This process of warehouse financing is called temporary financing, as it is meant to be in place temporarily, usually no longer than one year.

As HEIFS is working with the homeowner on the HEIFS financing, it alerts the warehouse lender(s) that a HEIFS transaction is likely to be closed in a certain time period (e.g., several weeks). At the time a HEIFS transaction is closed, and all documents have been signed, HEIFS provides the warehouse lender with electronic copies of the documents the warehouse lender requires in order to approve financing. Since HEIFS will only originate HEIFS according to certain underwriting guidelines initially established by the warehouse lender(s), each HEIFS transaction that HEIFS closed is fully expected to be funded by the warehouse lender(s). The warehouse lender will also require that the physical documents be sent to a custodian, who will store the documents in safekeeping for both the warehouse lender while the HEIFS transaction is being financed on the warehouse lines, but also after the warehouse financing has been paid off via securitization. Depending on the terms of the warehouse financing, HEIFS will either pay interest to the warehouse lender(s) periodically while the HEIFS transaction is on the warehouse line, or only at the time the HEIFS transaction comes off the warehouse line as a result of securitization financing. At the time of securitization or at the expiry of the warehouse line term, HEIFS will repay in full (plus interest) the amount that was borrowed to fund the HEIFS transaction.

The relationship between the insurance carrier, which issues the insurance policy that was recommended by the agents or advisors, and HEIFS involves the following. The insurance carrier will allow HEIFS financing on certain insurance products that the carrier issues. Agents or advisors maintain a relationship with the insurance carrier through the process of originating a policy for the agents or advisors' client, and that relationship, and much of the information surrounding the policyholder, remains between the agents or advisors and the carrier. Once the policy has been issued and funded by HEIFS, the insurance carrier will pay HEIFS a percentage of the total commission allowed on policy(s) issued by the carrier that was funded through HEIFS

Once HEIFS has originated a certain amount of HEIFS dollar volume, it will look to securitize the HEIFS collateral into more permanent financing involving the use of traditional asset-backed financing. As an example, the following process will be followed. Once HEIFS achieves a critical mass of volume, for example, in excess of 100 million dollars, of HEIFS originated and being financed on warehouse lines, HEIFS will establish a cut-off date and determine the exact size of the pool and its related characteristics. HEIFS will engage the services of a rating agency(s) to establish rating agency criteria which will allow for running the pool through the rating agency model that generates cash flows for each rating level (typically AAA through BBB), which allows HEIFS to size the deal by rating tranche. For example, a $100 million pool of HEIFS may be sized as follows: $65 million as an AAA rating level; $15 million as an AA rating level; $12 million as an A rating level; and $8 million as a BBB rating level.

HEIFS will engage the services of an underwriter, who will work with HEIFS in the marketing of the deal, as well as the services of securitization counsel, who will help document the transaction. This process can take 1-2 months, and once completed, HEIFS will simultaneously deposit the collateral into a securitization trust, which is a special purpose vehicle established specifically to issue securities collateralized by HEIFS deposited to the trust, and will have sold the securities to institutional investors.

Once the securities have been sold, the proceeds from the sale of the securities will be used to repay the warehouse lender(s), pay for the services of the underwriter, securitization counsel, rating agency(s), and other entities involved in the securitization process. Any proceeds remaining after all stakeholders have been paid off is called the net gain on sale, and those proceeds remain with HEIFS.

As discussed above, once the HEIFS financing has been closed and funded, HEIFS will “board” the HEIFS financing with its sub-servicer. This involves the following. Electronically uploading certain relevant information about the homeowner and the property to the sub-servicer, so that information can be downloaded into the sub-servicer system. Usually, a welcome letter is sent from HEIFS and the sub-servicer, informing the HEIFS homeowners as to who will be the primary contact at the sub-servicer, and what obligations the HEIFS homeowner should expect (for example, paying taxes and insurance on a timely basis), as well as what kind of communication will be sent to the HEIFS homeowner on a periodic basis, such as quarterly or annual statements informing the HEIFS homeowner what the balance of their HEIFS financing is at that point in time. Otherwise, given the fact that there are no payments required to be made from the HEIFS homeowner to HEIFS until the homeowner passes away or permanently moves out of their home, the amount of interaction between the sub-servicer and the HEIFS homeowner is limited.

HEIFS will engage with one or more reinsurance companies for multiple reasons. Reinsurers play an important role in managing the risk that insurance carriers take on when the carrier issues an insurance policy to a policyholder. For example, if the insurance policy is a life insurance policy, then the insurance carrier is taking mortality risk in that should the policyholder pass away earlier than expected, the insurance carrier pays out a death benefit far in excess of the premiums (and reinvestment income on the premiums) that the insurance carrier earned. To counter this risk, carriers will often cede some of the premiums to a reinsurer, who will take, in this example, the mortality risk associated with issuing the life insurance policy.

Given the fact that HEIFS funds the premiums that allow the insurance policies to be issued, HEIFS has significant influence in whether and how much of the insurance premiums will be ceded to a reinsurer. HEIFS can benefit from this type of influence by creating a partnership (often referred to as a reinsurance joint venture) with the reinsurer, where HEIFS can benefit from any reinsurance revenue that the reinsurer earns from the premiums ceded to the reinsurer associated with the insurance policy funded by HEIFS. Notably, HEIFS has the ability to work with the reinsurer, brokerage general agencies (BGAs), agents or advisors, and carriers to create proprietary insurance products that are custom designed to better fit the funding profile of an insurance policy that is funded by HEIFS. For example, when a policy is disclosed to a client, the agents or advisors show the client what the financial returns are to the client, measured in internal rate of return (IRR) calculations, when certain events are triggered, such as a death benefit claim, or a long-term care benefit claim. The same calculations are made when the insurance policy is funded by HEIFS, which gives the agents or advisors and their clients the ability to compare and contrast the IRR when an insurance policy is funded with cash vs. HEIFS. There may be instances when “off the shelf” insurance policies will show that HEIFS funding IRRs are better the majority of the time vs. cash funding, but not 100% of the time. With some proprietary insurance product development, the policy can be customized such that HEIFS funding produces IRRS that are either always better, or nearly always better than cash IRRS. This will allow agents or advisors to approach their clients knowing that HEIFS financing is clearly a better value proposition for their clients than using cash, which makes the recommendation for using HEIFS financing easier for the agents or advisors to make. This also allows HEIFS and the reinsurer a greater ability to influence how much of the premium is ceded back to the reinsurer, which ultimately benefits the reinsurer and HEIFS, to the extent HEIFS has a revenue-sharing arrangement in place with the reinsurer.

Importantly, the methods described above are fundamentally different from so-called endowment mortgages that involve the use of a life insurance product to structure mortgages that are used to buy a house or refinance an existing mortgage on a house. In those methods, nearly all mortgages are principal and interest amortizing mortgages, which means that the principal balance is paid down each pay period over a period of time consistent with the term of the mortgage (e.g., 30 years for a 30-year mortgage). This results in a situation in that, over time, the principal balance of the mortgage declines, and home equity increases, assuming the house does not fall in value. However, it is not necessary that the principal payment be used to pay down the principal of the mortgage; rather, the principal payment could be used to fund an investment, and that investment is used to pay off the mortgage at the end of its term. These types of mortgages involve an asset manager in the transaction, who manages the principal payments paid from the mortgage borrower to the asset manager, and is required to pay off the mortgage at the end of the mortgage's term. The asset manager, however, will often require that the mortgage borrower buy life insurance to cover the risk that should the mortgage borrower pass away early in the mortgage life, the mortgage borrower will receive sufficient life insurance proceeds to pay off the mortgage. This type of method is completely different than HEIFS disclosed herein. Again, endowment mortgages use mortgages and insurance to purchase a home, or refinance an existing mortgage on their home, whereas HEIFS involves taking the financing to purchase an insurance policy. Also, endowment mortgages require monthly interest payments, and “principal” payments used to fund the investment account, whereas with HEIFS, no payment is required. Additionally, endowment mortgages are usually up to 80% of the value of the mortgage borrower's property, whereas with HEIFS, the most that will generally be financed is up to 50%. Lastly, endowment mortgages require to be in a first-lien position, whereas HEIFS can be in a second lien position.

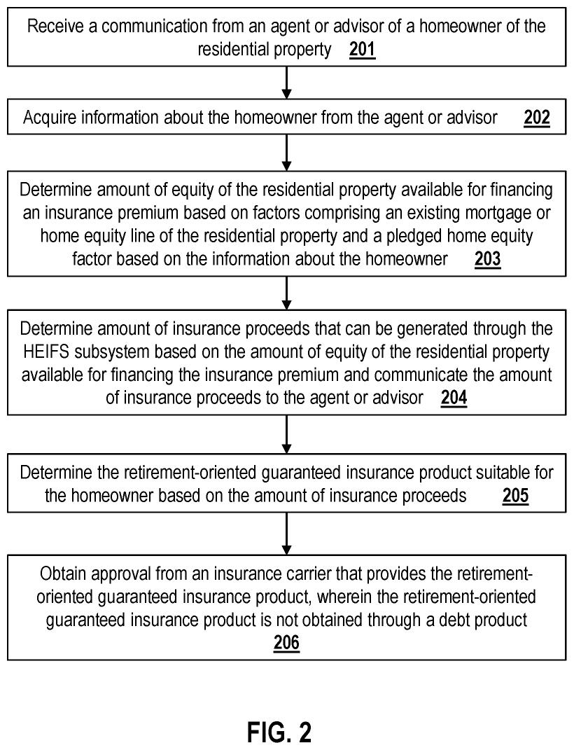

Referring now to FIG. 2, a method of obtaining a retirement-oriented insurance product using the equity of residential property through a home equity insurance financing solutions (HEIFS) subsystem is illustrated. In some embodiments, the amount of equity of the residential property available for financing the insurance premium is not leveraged through the debt product. In some embodiments, the method does not require payments from the homeowner until the homeowner passes away or permanently moves out of the residential property.

At 201, the method starts with receiving, by the HEIFS subsystem, a communication from an agent or advisor of a homeowner of the residential property, wherein the communication is indicative of an intent of the homeowner to purchase a retirement-oriented insurance product that is pre-approved by the HEIFS subsystem. In some embodiments, the residential property is a single-family house.

In some embodiments, the retirement-oriented insurance product may include one or more of annuity, life insurance, and long-term care insurance. In some embodiments, the retirement-oriented insurance product may include a life insurance policy (e.g., Fixed universal, Index universal, Variable universal, Whole Life, Level term, Decreasing term (Along with ALL available riders); survivorship, whole life, fixed universal, index and private placement; Individual long term care (LTC), Hybrid LTC, Annuities with LTC triggers; Annuities: Immediate annuity, Deferred income annuity, Multi year guaranteed (MYGA), and Variable annuity; Private Placement variable universal life; Private placement annuities; and the like).

At step 202, the method may include acquiring, by the HEIFS subsystem, information about the homeowner from the agent or advisor. In some embodiments, the information about the homeowner may include one or more of the name of the homeowner, the address of the residential property, an estimated home value of the residential property, and existing mortgage or debt on the residential property.

At step 203, the method may include determining, by the HEIFS subsystem, the amount of equity of the residential property available for financing an insurance premium based on factors that may include an existing mortgage or home equity line of the residential property and a pledged home equity factor based on the information about the homeowner.

In some embodiments, the amount of equity of the residential property available for financing the insurance premium is calculated by the following equation:

VE=(p*value of the residential property−the existing mortgage or home equity line)/the pledged home equity factor,
wherein VE is the amount of equity of the residential property available for financing the insurance premium, and p is a percentage of the value of the residential property that is permitted for financing the insurance premium. In some embodiments, p is about 50% of the value of the residential property. In some embodiments, the pledged home equity factor is from about 1.5 to about 3, such as 2.

In some embodiments, the HEIFS subsystem may include a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the model may include one or more machine learning models. In some embodiments, the model may include a neural network, a convolutional neural network (CNN), a deep convolutional neural network (DCNN), a cascaded deep convolutional neural network, a simplified CNN, a shallow CNN, or a combination thereof. In some embodiments, the HEIFS subsystem uses the model to determine the amount of equity of the residential property available for financing the insurance premium.

At step 204, the method may include determining, by the HEIFS subsystem, the amount of insurance proceeds that can be generated through the HEIFS subsystem based on the amount of equity of the residential property available for financing the insurance premium and communicating the amount of insurance proceeds to the agent or advisor.

In some embodiments, the amount of insurance proceeds available to be used by the agents or advisors is determined through a typical wholesaling relationship the agents or advisors will have with a brokerage general agency (“BGA”). The BGA will have access to HEIFS's financing model, and through inputting information about the homeowner's home value and possible other liens on the property, the wholesaler at the BGA can assist the agents or advisors in determining how much proceeds are available on a HEIFS transaction. At that point, the HEIFS subsystem determines the maximum proceeds available to be used to finance the insurance premium on the recommended insurance policy.

In some embodiments, the HEIFS subsystem uses a model to determine insurance proceeds that can be generated through the HEIFS subsystem based on the amount of equity of the residential property available for financing the insurance premium. In some embodiments, the model may be based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the model may include one or more machine learning models. In some embodiments, the model may include a neural network, a convolutional neural network (CNN), a deep convolutional neural network (DCNN), a cascaded deep convolutional neural network, a simplified CNN, a shallow CNN, or a combination thereof.

At step 205, the method may include determining, by the HEIFS subsystem, the retirement-oriented insurance product suitable for the homeowner based on the amount of insurance proceeds. In some embodiments, the HEIFS subsystem may use a classifier to identify a suitable retirement orientated insurance product. In some embodiments, the classifier may include a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the classifier may include one or more machine learning models. In some embodiments, the classifier may include a neural network, a convolutional neural network (CNN), a deep convolutional neural network (DCNN), a cascaded deep convolutional neural network, a simplified CNN, a shallow CNN, or a combination thereof.

At step 206, the method may include obtaining, by the HEIFS subsystem, approval from an insurance carrier that provides the retirement-oriented insurance product, wherein the retirement-oriented insurance product is not obtained through a debt product.

In some embodiments, the method may further include engaging, by the HEIFS subsystem, an underwriter to finance the insurance premium. In some embodiments, the underwriter is a warehouse lender.

In some embodiments, the method may further include securitizing, by the HEIFS subsystem, collaterals associated with financing the insurance premium.

In some embodiments, the method may further include engaging, by the HEIFS subsystem, one or more reinsurance companies to reinsure the retirement-oriented insurance product.

In some embodiments, the method may further include determining, by the HEIFS subsystem, the value of the residential property through one or more automated valuation models.

In some embodiments, the method may further include taking, by the HEIFS subsystem, a second lien position if there is an existing lien associated with the residential property.

In another aspect, this disclosure provides a system of obtaining a retirement-oriented insurance product using the equity of residential property through a home equity insurance financing solutions (HEIFS) subsystem. In some embodiments, the HEIFS subsystem is configured to: (a) receive a communication from an agent or advisor of a homeowner of the residential property, wherein the communication is indicative of an intent of the homeowner to purchase a retirement-oriented insurance product that is pre-approved by the HEIFS subsystem; (b) acquire information about the homeowner from the agent or advisor; (c) determine amount of equity of the residential property available for financing an insurance premium based on factors comprising an existing mortgage or home equity line of the residential property and a pledged home equity factor based on the information about the homeowner; (d) determine amount of insurance proceeds that can be generated through the HEIFS subsystem based on the amount of equity of the residential property available for financing the insurance premium and communicate the amount of insurance proceeds to the agent or advisor; (e) determine the retirement-oriented insurance product suitable for the homeowner based on the amount of insurance proceeds; and (f) obtain approval from an insurance carrier that provides the retirement-oriented insurance product, wherein the retirement-oriented insurance product is not obtained through a debt product.

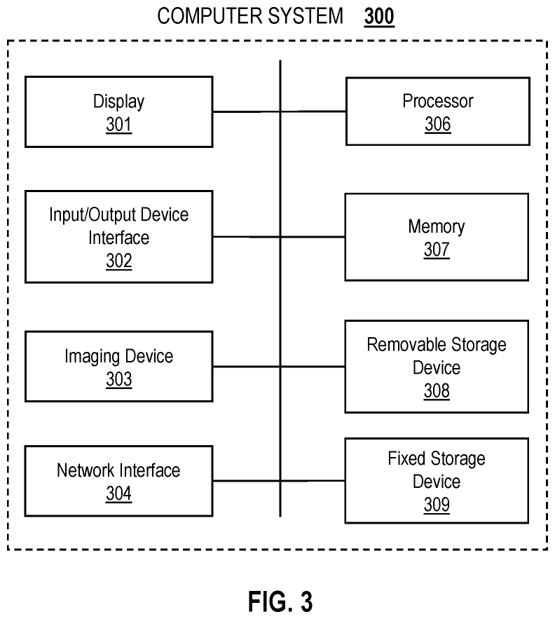

FIG. 3 shows a functional diagram illustrating a programmed computer system in accordance with some embodiments. As will be apparent, other computer system architectures and configurations can be used to perform the described methods. Computer system 300, which includes various subsystems as described below, includes at least one microprocessor subsystem (also referred to as a processor or a central processing unit (CPU) 306). For example, processor 306 can be implemented by a single-chip processor or by multiple processors. In some embodiments, processor 306 is a general-purpose digital processor that controls the operation of the computer system 300. In some embodiments, processor 306 also includes one or more coprocessors or special-purpose processors (e.g., a graphics processor, a network processor, etc.). Using instructions retrieved from memory 307, processor 306 controls the reception and manipulation of input data received on an input device (e.g., image processing device 303, I/O device interface 302), and the output and display of data on output devices (e.g., display 301).

Processor 306 is coupled bi-directionally with memory 307, which can include, for example, one or more random access memories (RAM) and/or one or more read-only memories (ROM). As is well known in the art, memory 307 can be used as a general storage area, a temporary (e.g., scratchpad) memory, and/or a cache memory. Memory 307 can also be used to store input data and processed data, as well as to store programming instructions and data, in the form of data objects and text objects, in addition to other data and instructions for processes operating on processor 306. Also, as is well known in the art, memory 307 typically includes basic operating instructions, program code, data, and objects used by the processor 306 to perform its functions (e.g., programmed instructions). For example, memory 307 can include any suitable computer-readable storage media described below, depending on whether, for example, data access needs to be bi-directional or uni-directional. For example, processor 306 can also directly and very rapidly retrieve and store frequently needed data in a cache memory included in memory 307.

A removable mass storage device 308 provides additional data storage capacity for the computer system 300 and is optionally coupled either bi-directionally (read/write) or uni-directionally (read-only) to processor 306. A fixed mass storage 309 can also, for example, provide additional data storage capacity. For example, storage devices 308 and/or 309 can include computer-readable media such as magnetic tape, flash memory, PC-CARDS, portable mass storage devices such as hard drives (e.g., magnetic, optical, or solid-state drives), holographic storage devices, and other storage devices. Mass storages 308 and/or 309 generally store additional programming instructions, data, and the like that typically are not in active use by the processor 306. It will be appreciated that the information retained within mass storages 308 and 309 can be incorporated, if needed, in a standard fashion as part of memory 307 (e.g., RAM) as virtual memory.

In addition to providing processor 306 access to storage subsystems, bus 310 can be used to provide access to other subsystems and devices as well. As shown, these can include a display 301, a network interface 304, an input/output (I/O) device interface 302, an image processing device 303, as well as other subsystems and devices. For example, image processing device 303 can include a camera, a scanner, etc.; I/O device interface 302 can include a device interface for interacting with a touchscreen (e.g., a capacitive touch-sensitive screen that supports gesture interpretation), a microphone, a sound card, a speaker, a keyboard, a pointing device (e.g., a mouse, a stylus, a human finger), a global positioning system (GPS) receiver, a differential global positioning system (DGPS) receiver, an accelerometer, and/or any other appropriate device interface for interacting with system 300. Multiple I/O device interfaces can be used in conjunction with computer system 300. The I/O device interface can include general and customized interfaces that allow the processor 306 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 303 allows processor 306 to be coupled to another computer, computer network, or telecommunications network using a network connection as shown. For example, through the network interface 304, the processor 306 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 306 can be used to connect the computer system 300 to an external network and transfer data according to standard protocols. For example, various process embodiments disclosed herein can be executed on processor 306 or can be performed across a network such as the Internet, intranet networks, or local area networks, in conjunction with a remote processor that shares a portion of the processing. Additional mass storage devices (not shown) can also be connected to processor 306 through network interface 304.

In addition, various embodiments disclosed herein further relate to computer storage products with a computer-readable medium that includes program code for performing various computer-implemented operations. The computer-readable medium includes any data storage device that can store data that can thereafter be read by a computer system. Examples of computer-readable media include, but are not limited to, magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system as shown in FIG. 3 is an example of a computer system suitable for use with the various embodiments disclosed herein. Other computer systems suitable for such use can include additional or fewer subsystems. In some computer systems, subsystems can share components (e.g., for touchscreen-based devices such as smartphones, tablets, etc., I/O device interface 302 and display 301 share the touch-sensitive screen component, which both detects user inputs and displays outputs to the user). In addition, bus 310 is illustrative of any interconnection scheme serving to link the subsystems. Other computer architectures having different configurations of subsystems can also be utilized.

### Additional Definitions

To aid in understanding the detailed description of the compositions and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

The terms or acronyms like “convolutional neural network,” “CNN,” “neural network,” “NN,” “deep neural network,” “DNN,” “recurrent neural network,” “RNN,” and/or the like may be interchangeably referenced throughout this document.

Aspects of the present disclosure are described herein with reference to flowchart illustrations and/or block diagrams of methods, apparatus (systems), and computer program products according to embodiments of the invention. In some embodiments, the flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

These computer-readable program instructions may be provided to a processor of a general-purpose computer, a special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

It will be understood that, although the terms “first,” “second,” etc., may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Unless specifically stated otherwise, as apparent from the above discussion, it is appreciated that throughout the description, discussions utilizing terms such as “processing,” “performing,” “receiving,” “computing,” “calculating,” “determining,” “identifying,” “displaying,” “providing,” “merging,” “combining,” “running,” “transmitting,” or the like, refer to the action and processes of a computer system, or similar electronic computing device, that manipulates and transforms data represented as physical (or electronic) quantities within the computer system memories or registers or other such information storage, transmission or display devices.

It is noted here that, as used in this specification and the appended claims, the singular forms “a,” “an,” and “the” include plural reference unless the context clearly dictates otherwise. The terms “including,” “comprising,” “containing,” or “having” and variations thereof are meant to encompass the items listed thereafter and equivalents thereof as well as additional subject matter unless otherwise noted.

As used herein, “plurality” means two or more. As used herein, a “set” of items may include one or more of such items.

The phrases “in one embodiment,” “in various embodiments,” “in some embodiments,” and the like are used repeatedly. Such phrases do not necessarily refer to the same embodiment, but they may unless the context dictates otherwise.

The terms “and/or” or “/” means any one of the items, any combination of the items, or all of the items with which this term is associated.

The term “if may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

As used herein, the term “each,” when used in reference to a collection of items, is intended to identify an individual item in the collection but does not necessarily refer to every item in the collection. Exceptions can occur if explicit disclosure or context clearly dictates otherwise.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All methods described herein are performed in any suitable order unless otherwise indicated herein or otherwise clearly contradicted by context. In regard to any of the methods provided, the steps of the method may occur simultaneously or sequentially. When the steps of the method occur sequentially, the steps may occur in any order, unless noted otherwise.

In cases in which a method comprises a combination of steps, each and every combination or sub-combination of the steps is encompassed within the scope of the disclosure, unless otherwise noted herein.

Each publication, patent application, patent, and other reference cited herein is incorporated by reference in its entirety to the extent that it is not inconsistent with the present disclosure. Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates which may need to be independently confirmed.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A system of obtaining a retirement-oriented insurance product using equity of a residential property through a home equity insurance financing solutions (HEIFS) subsystem, wherein the HEIFS subsystem is configured to:
receive a communication from an agent or advisor of a homeowner of the residential property, wherein the communication is indicative of an intent of the homeowner to purchase a retirement-oriented insurance product that is pre-approved by the HEIFS subsystem;
acquire information about the homeowner from the agent or advisor;
determine amount of equity of the residential property available for financing an insurance premium based on factors comprising an existing mortgage or home equity line of the residential property and a pledged home equity factor based on the information about the homeowner;
determine amount of insurance proceeds that can be generated through the HEIFS subsystem based on the amount of equity of the residential property available for financing the insurance premium and communicate the amount of insurance proceeds to the agent or advisor;
determine the retirement-oriented insurance product suitable for the homeowner based on the amount of insurance proceeds; and
obtain approval from an insurance carrier that provides the retirement-oriented insurance product,
wherein the retirement-oriented insurance product is not obtained through a debt product.

2. The system of claim 1, wherein the amount of equity of the residential property available for financing the insurance premium is not leveraged through the debt product.

3. The system of claim 1, wherein the system does not require payments from the homeowner until the homeowner passes away or permanently moves out of the residential property.

4. The system of claim 1, wherein the HEIFS subsystem is further configured to engage an underwriter to finance the insurance premium.

5. The system of claim 4, wherein the underwriter is a warehouse lender.

6. The system of claim 1, wherein the HEIFS subsystem is further configured to securitize collaterals associated with financing the insurance premium.

7. The system of claim 1, wherein the HEIFS subsystem is further configured to engage one or more reinsurance companies to reinsure the retirement-oriented insurance product.

8. The system of claim 1, wherein the residential property is a single-family house.

9. The system of claim 1, wherein the retirement-oriented insurance product comprises one or more of annuity, life insurance, and long-term care insurance.

10. The system of claim 9, wherein the retirement-oriented insurance product comprises a life insurance policy.

11. The system of claim 1, wherein the information about the homeowner comprises one or more of a name of the homeowner, an address of the residential property, an estimated home value of the residential property, and existing mortgage or debt on the residential property.

12. The system of claim 1, wherein the amount of equity of the residential property available for financing the insurance premium is calculated by the following equation:
VE=(p*value of the residential property−the existing mortgage or home equity line)/the pledged home equity factor,
wherein VE is the amount of equity of the residential property available for financing the insurance premium, and p is a percentage of the value of the residential property that is permitted for financing the insurance premium.

13. The system of claim 12, wherein p is about 50% of the value of the residential property.

14. The system of claim 12, wherein the pledged home equity factor is from about 1.5 to about 3.

15. The system of claim 1, wherein the HEIFS subsystem is further configured to determine the value of the residential property through one or more automated valuation models.

16. The system of claim 1, wherein the HEIFS subsystem is further configured to take a second lien position if there is an existing lien associated with the residential property.

17. A method of obtaining a retirement-oriented insurance product using equity of a residential property through a home equity insurance financing solutions (HEIFS) subsystem, comprising:
receiving, by the HEIFS subsystem, a communication from an agent or advisor of a homeowner of the residential property, wherein the communication is indicative of an intent of the homeowner to purchase a retirement-oriented insurance product that is pre-approved by the HEIFS subsystem;
acquiring, by the HEIFS subsystem, information about the homeowner from the agent or advisor;
determining, by the HEIFS subsystem, amount of equity of the residential property available for financing an insurance premium based on factors comprising an existing mortgage or home equity line of the residential property and a pledged home equity factor based on the information about the homeowner;
determining, by the HEIFS subsystem, amount of insurance proceeds that can be generated through the HEIFS subsystem based on the amount of equity of the residential property available for financing the insurance premium and communicating the amount of insurance proceeds to the agent or advisor;
determining, by the HEIFS subsystem, the retirement-oriented insurance product suitable for the homeowner based on the amount of insurance proceeds; and obtaining, by the HEIFS subsystem, approval from an insurance carrier that provides the retirement-oriented insurance product,
wherein the retirement-oriented insurance product is not obtained through a debt product.

18. The method of claim 1, wherein the amount of equity of the residential property available for financing the insurance premium is not leveraged through the debt product.

19. The method of claim 1, wherein the method does not require payments from the homeowner until the homeowner passes away or permanently moves out of the residential property.

20. The method of claim 1, further comprising engaging, by the HEIFS subsystem, an underwriter to finance the insurance premium.

21. The method of claim 17, wherein the underwriter is a warehouse lender.

22. The method of claim 17, further comprising securitizing, by the HEIFS subsystem, collaterals associated with financing the insurance premium.

23. The method of claim 17, further comprising engaging, by the HEIFS subsystem, one or more reinsurance companies to reinsure the retirement-oriented insurance product.

24. The method of claim 17, wherein the residential property is a single-family house.

25. The method of claim 17, wherein the retirement-oriented insurance product comprises one or more of annuity, life insurance, and long-term care insurance.

26. The method of claim 25, wherein the retirement-oriented insurance product comprises a life insurance policy.

27. The method of claim 17, wherein the information about the homeowner comprises one or more of a name of the homeowner, an address of the residential property, an estimated home value of the residential property, and existing mortgage or debt on the residential property.

28. The method of claim 17, wherein the amount of equity of the residential property available for financing the insurance premium is calculated by the following equation:
VE=(p*value of the residential property−the existing mortgage or home equity line)/the pledged home equity factor,
wherein VE is the amount of equity of the residential property available for financing the insurance premium, and p is a percentage of the value of the residential property that is permitted for financing the insurance premium.

29. The method of claim 28, wherein p is about 50% of the value of the residential property.

30. The method of claim 28, wherein the pledged home equity factor is from about 1.5 to about 3.

31. The method of claim 17, further comprising determining, by the HEIFS subsystem, the value of the residential property through one or more automated valuation models.

32. The method of claim 17, further comprising, by the HEIFS subsystem, taking a second lien position if there is an existing lien associated with the residential property.
